(19) United States
(12) Patent Application Publication
(10) Pub. No.: US 2025/0309268 A1
(43) Pub. Date: Oct. 2, 2025

(54) BINDERS FOR ELECTRODES

(71) Applicant: FORD GLOBAL TECHNOLOGIES, LLC, Dearborn, MI (US)

(72) Inventors: Insik JEON, Novi, MI (US); Jonghwan PARK, Ann Arbor, MI (US)

(21) Appl. No.: 18/624,971

(22) Filed: Apr. 2, 2024

(51) Int. Cl. H01M 4/62; H01M 4/04; H01M 4/139; H01M 10/0525

(52) U.S. Cl. CPC H01M 4/622; H01M 4/0435; H01M 4/139; H01M 10/0525

(57) ABSTRACT

A lithium-ion battery component in presented. The lithium-ion battery component has an electrode with a current collector and an electrode sheet laminated thereon including conducting agents and a polar cross-linkable co-polymeric binder of butadiene isomers and acrylonitrile mechanically binding the conducting agents in a sterically stabilized dispersion configured to permit volume expansion of the electrode sheet during charge of the electrode and facilitate volume contraction of the electrode sheet during discharge.

### TECHNICAL FIELD

The disclosure relates to binder materials for lithium-ion batteries.

### BACKGROUND

For lithium-ion batteries, polyvinylidene fluoride (PVDF) has been a material of choice for cathode binders, playing a role in electrode formulation. However, PVDF has structural limitations, which result in insufficient lithium-ion conductivity, which may be more pronounced in high voltage/oxidation cell chemistries. Additionally, PVDF lacks the necessary functionalities to effectively disperse conducting materials, such as carbon black, carbon nanotubes (CNT), and their equivalents, within the electrode matrix. This inadequacy often necessitates the incorporation of additional dispersants into the electrode formulation to ensure adequate power output and maintain low direct current internal resistance (DC-IR) characteristics. However, the inclusion of these non-binder type additives compromises the loading of cathode active materials, subsequently reducing the cell's volumetric energy density. Given these constraints, there is a need to explore and develop alternative binder materials.

### SUMMARY

In one aspect of the disclosure, a lithium-ion battery component is presented. The lithium-ion battery component has an electrode having a current collector and an electrode sheet laminated thereon including conducting agents and a polar cross-linkable co-polymeric binder of butadiene isomers and acrylonitrile mechanically binding the conducting agents in a sterically stabilized dispersion and configured to permit volume expansion of the electrode sheet during charge of the electrode and to facilitate volume contraction of the electrode sheet during discharge. At least 50% of the butadiene isomers in the polar cross-linkable co-polymeric binder may be reduced 1,4-butadiene isomers. In some configurations, 99% of the butadiene isomers in the polar cross-linkable co-polymeric binder are reduced 1,4-butadiene isomers. Less than 10% of the butadiene isomers in the polar cross-linkable co-polymeric binder may be unsaturated butadiene isomers. The acrylonitrile to butadiene isomer ratio may range from 1:0.1 to 1:0.9. The conducting agents may include carbon black. The conducting agents may also include carbon nanotubes. The electrode sheet may include lithium-manganese rich electrode materials.

In another aspect of the disclosure, a method is presented. Initially, a polar cross-linkable co-polymeric binder, of butadiene isomers and acrylonitrile, is mixed with conducting agents to create a sterically dispersed mixture. The method continues with the addition of electrode active materials to the mixture and forming a self-supporting electrode film. The electrode film is then roll-pressed together with a current collector forming a laminated electrode. The ratio of acrylonitrile to butadiene isomer in the polar cross-linkable co-polymeric binder may be at least 1:0.2. Less than 10% of the butadiene isomers within the polar cross-linkable co-polymeric binder may be unsaturated butadiene isomers. At least 50% of the butadiene isomers within the polar cross-linkable co-polymeric binder may be reduced 1,4-butadiene isomers. An additional step in the method may include blending the polar cross-linkable co-polymeric binder with polyvinylidene fluoride. This blend may be in a ratio ranging from 0.001:1 to 1:1, with a ratio of 0.2:1 ratio preferred.

In yet another aspect of the disclosure, a lithium-ion battery is presented. The lithium-ion battery has a separator and a pair of electrodes that sandwich the separator. At least one of the electrodes includes an electrode sheet laminated with a current collector, which includes conducting agents and a polar cross-linkable co-polymeric binder of butadiene isomers and acrylonitrile. This binder mechanically binds the conducting agents in a sterically stabilized dispersion that allows the electrode sheet to expand during the battery's charging cycle and contract during discharge. In some configurations, 99% of the butadiene isomers in the polar cross-linkable co-polymeric binder are reduced 1,4-butadiene isomers. The polar cross-linkable co-polymeric binder may have a ratio of butadiene isomers to acrylonitrile of 1:0.2. The polar cross-linkable co-polymeric binder may be blended with polyvinylidene fluoride at a ratio of 0.2:1. The conducting agents dispersed within the electrode sheet may include carbon black, carbon nanotubes, or both. The electrode sheet may include lithium-manganese rich electrode materials.

### BRIEF DESCRIPTION OF THE DRAWINGS

FIG. 1 is a schematic diagram of a polar cross-linkable co-polymeric binder and its substitute groups according to any one or more aspects of the disclosure;

FIG. 2 is a schematic diagram of a lithium-ion battery component containing a polar cross-linkable co-polymeric binder according to any one or more aspects of the disclosure; and

FIG. 3 is a flowchart of a manufacturing process according to any one or more aspects of the disclosure.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Unless otherwise explicitly specified, all numerical values and ranges relating to quantities, measurements, percentages, weights, and similar numerical references within this document are to be understood as being preceded by the term “about.” This applies even in cases where the term “about” is not explicitly used. It is intended that all values and ranges encompass variations that may arise from standard measurement, manufacturing processes, material properties, and intended functionality of aspects of the disclosure. For example, when a composition is described as having “5 wt. % of a component,” it is to be understood as “about 5 wt. % of a component.” Furthermore, when numerical values are presented as a range, such as “100 to 200 units,” this range should be interpreted to effectively mean “about 100 to about 200 units.” Such variations are implicitly incorporated within the scope of the present disclosure.

Recognizing limitations presented by traditional cathode binders like PVDF in lithium-ion batteries, the disclosure explores alternative binders. In one aspect, utilizing co-polymers to increase both lithium-ion conductivity and the dispersion of conductive agents within the electrode matrix is proposed. The co-polymeric binders may have two primary components: butadiene isomers (component A) and acrylonitrile (component B), each selected for their contributions to the overall performance of the binder.

Butadiene isomers, which form the backbone of component A, are selected for their ability to impart elastomeric flexibility to the binder. This flexibility maintains the structural integrity of the electrode under the mechanical influences that occur during the battery's charging and discharging cycles. Moreover, the inherent flexibility provided by the butadiene isomers increases the binder's capability to facilitate the uniform dispersion of conductive agents (such as carbon black, CNT, and other equivalents), as well as cathode active materials within the electrode. This uniform dispersion maintains consistent electrical conductivity across the electrode, which in turn, contributes to the overall efficiency and performance of the battery.

Component B, acrylonitrile, brings a different set of properties to the co-polymer. The presence of a negative dipole in the acrylonitrile units contributes to voltage and oxidation stability, particularly in high-voltage or oxidation-prone cell chemistries like those involving lithium manganese-rich (LMR) cathodes. This stability maintains battery performance and longevity, under the conditions required for fast charging and high power output in applications.

In another aspect of the disclosure, a polar cross-linkable co-polymeric binder is presented, with a specific ratio of butadiene isomers to acrylonitrile (A-B ratio), and a selected percentage of 1,4-butadiene isomers. By tuning the ratio of unsaturated butadiene within the binder, the disclosure addresses poor lithium-ion conductivity and inadequate dispersion of conducting agents and introduces an array of butadiene isomeric structures. These structures increase the electrode's flexibility, maintain voltage and oxidation stability, and increase the dispersion of conducting agents within an electrode.

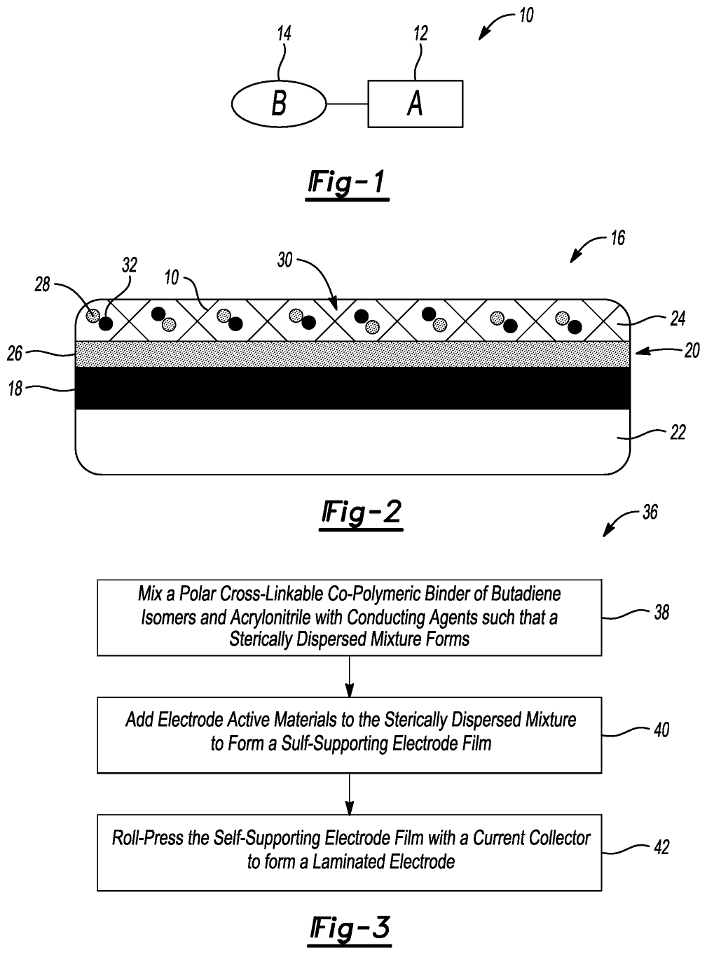

Referring now to FIG. 1, a schematic diagram of a polar cross-linkable co-polymeric binder 10 is shown. The polar cross-linkable co-polymeric binder 10 may be incorporated in lithium-ion batteries. This binder combines butadiene isomers 12 in the A group, for imparting elastomeric flexibility, with acrylonitrile 14 in the B group, for increasing chemical stability and adhesion. Specifically, the butadiene component 12 allows the binder to flexibly adapt to volume changes during battery cycles, mitigating any electrode cracking and increasing overall electrode flexibility. A composition with no more than 10% unsaturated butadiene isomers is preferred for oxidation stability. This formulation promotes the dispersion of conductive agents like carbon black and CNT, along with cathode active materials, for uniform electrical conductivity and electrode integrity. The cathode active materials may be any suitable active materials such as LMR-based active materials.

Acrylonitrile 14 is selected for its negative dipole from the CN group, maintaining voltage and oxidation stability. Its strong bonding capabilities with conductive particles increase particle dispersion and adhesion to current collectors, while also increasing the binder's oxidation resistance. The formulation may have a ratio of A to B in ranges from 1:0.1 to 1:0.9, with a preferred ratio of 1:0.2. The butadiene component 12 is processed so that reduced 1,4-butadiene isomers are at least 50% of the butadiene isomers 12, for a mixture with predominantly unsaturated isomeric forms. In some configurations, it may be preferable to have over 99% of the butadiene isomers be 1,4-butadiene isomers. In an electrode formulation, the polar cross-linkable co-polymeric binder 10 may be utilized alone or in combination with other binders like PVDF. For mixed systems, the binder ratio of A-B to PVDF may vary from 0.001:1 to 1:1, with a preferred ratio of 0.2:1.

In FIG. 2, a lithium-ion battery component 16 is shown. The lithium-ion battery component 16 shown is a lithium-ion battery cell. The lithium-ion battery cell 16 has a separator 18 sandwiched between a pair of electrodes 20 and 22. The electrode 20 has an electrode sheet 24 laminated with a current collector 26 having conducting agents 28 sterically stabilized by the polar cross-linkable co-polymer 10 mechanically binding the dispersed conducting agents 28 in a sterically stabilized dispersion 30. The sterically stabilized dispersion 30 is configured to permit volume expansion of the electrode sheet 24 during charge of the electrode 20 and facilitate volume contraction of the electrode sheet 24 during discharge. While the electrode 20 is shown with the electrode sheet 24, the electrode sheet may be incorporated into either or both electrodes. The conducting agents 28 may be carbon black, carbon nanotubes or any other material with suitable electrochemical properties. The electrode sheet 24 includes active materials 32. The active materials 32 may be either anode or cathode materials such as lithium or graphite depending on the application.

To form the electrode sheet 24 the polar cross-linkable co-polymer 10 is mixed with the conducting agents 28 until the conducting agents 28 are sterically stabilized. Then the suitable active materials 32 are added to the binder 10 with sterically stabilized conducting agents 28 to form an electrode sheet 24. Suitable active materials may be LMR-based active materials or other traditional active materials. The conductive agents 28 may be carbon black, CNT, or other equivalents. The active materials 32 may optionally be mixed with other thermoplastic binders such as PVDF.

FIG. 3 is a flowchart of a manufacturing method 36 according to one or more embodiments of the disclosure. At step 38, the method 36 involves mixing a polar cross-linkable co-polymeric binder, which includes butadiene isomers and acrylonitrile, with conducting agents to produce a sterically dispersed mixture. This step achieves an even distribution of the conducting agents within the binder. In some configurations, the polar cross-linkable co-polymeric binder has an acrylonitrile to butadiene isomer ratio of at least 1:0.2, and less than 10% of the butadiene isomers are unsaturated, with a minimum of 50% being reduced 1,4-butadiene isomers. In other configurations, the polar cross-linkable co-polymeric binder may be blended with PVDF in ratios from 0.001:1 to 1:1, with a preferred ratio of 0.2:1. Proceeding to step 40, electrode active materials are then added to the previously prepared sterically dispersed mixture. This addition forms a self-supporting electrode film, which is a foundational component in the structure of an electrode.

Finally, at step 42, the self-supporting electrode film is roll-pressed along with a current collector. This step forms a laminated electrode, which is a structural element of a lithium-ion battery. The lamination makes it so that the electrode film and current collector are integrally bound, providing the mechanical support and electrical connectivity for the electrode's functionality within a battery. In some configurations, the laminated electrode may be further cured to promote cross-linking through thermal curing, catalytic processes, UV curing, E-beam laser application, or any other suitable method. Thermal curing involves heating the material, which initiates a chemical reaction leading to the cross-linking of polymer chains within the binder. Catalytic curing promotes the chemical reactions at lower temperatures or shorter times compared to thermal curing. Utilizing ultraviolet light, UV curing initiates the curing process without the need for heat, leading to rapid cross-linking of the binder.

E-beam curing employs high-energy electrons to induce cross-linking, offering fast curing times and the ability to penetrate deeply into the material. It is an environmentally friendly option that can cure materials without solvents, producing robust, chemically resistant films. This method is particularly effective when uniform curing throughout the thickness of the material is required.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A lithium-ion battery component comprising:
an electrode having a current collector and an electrode sheet laminated thereon including conducting agents and a polar cross-linkable co-polymeric binder of butadiene isomers and acrylonitrile mechanically binding the conducting agents in a sterically stabilized dispersion and configured to permit volume expansion of the electrode sheet during charge of the electrode and to facilitate volume contraction of the electrode sheet during discharge of the electrode.

2. The lithium-ion battery component of claim 1 wherein at least 50% of the butadiene isomers in the polar cross-linkable co-polymeric binder are reduced 1,4-butadiene isomers.

3. The lithium-ion battery component of claim 2 wherein 99% of the butadiene isomers in the polar cross-linkable co-polymeric binder are reduced 1,4-butadiene isomers.

4. The lithium-ion battery component of claim 1 wherein less than 10% of the butadiene isomers in the polar cross-linkable co-polymeric binder are unsaturated butadiene isomers.

5. The lithium-ion battery component of claim 1 wherein the acrylonitrile to butadiene isomer ratio ranges from 1:0.1 to 1:0.9.

6. The lithium-ion battery component of claim 1 wherein the conducting agents include carbon black.

7. The lithium-ion battery component of claim 1 wherein the conducting agents include carbon nanotubes.

8. The lithium-ion battery component of claim 1 wherein the electrode sheet includes lithium-manganese rich electrode materials.

9. A method comprising:
mixing a polar cross-linkable co-polymeric binder of butadiene isomers and acrylonitrile with conducting agents such that a sterically dispersed mixture forms;
adding electrode active materials to the sterically dispersed mixture to form a self-supporting electrode film; and
roll-pressing the self-supporting electrode film with a current collector to form a laminated electrode.

10. The method of claim 9 wherein the polar cross-linkable co-polymeric binder is prepared with an acrylonitrile to butadiene isomer ratio of at least 1:0.2.

11. The method of claim 9 wherein less than 10% of the butadiene isomers in the polar cross-linkable co-polymeric binder are unsaturated butadiene isomers.

12. The method of claim 9 wherein at least 50% of the butadiene isomers in the polar cross-linkable co-polymeric binder are reduced 1,4-butadiene isomers.

13. The method of claim 9, further comprising blending the polar cross-linkable co-polymeric binder with polyvinylidene fluoride in a ratio ranging from 0.001:1 to 1:1.

14. The method of claim 13 wherein the polar cross-linkable co-polymeric binder to polyvinylidene fluoride ratio is 0.2:1.

15. A lithium-ion battery comprising:
a separator; and
a pair of electrodes sandwiching the separator, at least one of the electrodes including an electrode sheet, laminated with a current collector, having dispersed conducting agents sterically stabilized by a polar cross-linkable co-polymer of butadiene isomers and acrylonitrile mechanically binding the dispersed conducting agents.

16. The lithium-ion battery of claim 15 wherein 99% of the butadiene isomers in the polar cross-linkable co-polymer are reduced 1,4-butadiene isomers.

17. The lithium-ion battery of claim 15 wherein the polar cross-linkable co-polymer has a ratio of butadiene isomers to acrylonitrile of 1:0.2.

18. The lithium-ion battery of claim 15 wherein the polar cross-linkable co-polymer is mixed with polyvinylidene fluoride ratio in a ratio of 0.2:1

19. The lithium-ion battery of claim 15 wherein the dispersed conducting agents dispersed in the electrode sheet include carbon black, carbon nanotubes, or a mixture of both.

20. The lithium-ion battery of claim 15 wherein the electrode sheet includes lithium-manganese rich electrode materials.
